(19) United States
(12) Patent Application Publication
(10) Pub. No.: US 2005/0120106 A1
(43) Pub. Date: Jun. 2, 2005

(54) System and method for distributing software updates to a network appliance

(75) Inventor: Felipe Albertao, Sunnyvale, CA (US)

Correspondence Address: DARBY & DARBY P.C., P.O. BOX 5257, NEW YORK, NY, 10150-6257, US

(73) Assignee: Nokia, Inc., Irving, TX (US)

(21) Appl. No.: 10/725,617

(22) Filed: Dec. 2, 2003

(51) Int. Cl. G06F 15/173

(52) U.S. Cl. 709/223

(57) ABSTRACT

Methods and systems are directed to enabling automatic delivery and installation software changes over a network to a network device, such as a network appliance. An update policy associated with the network device is generated that includes information associated with how to select a software change, when the software change is to be delivered, and when it is installed on the network device. The network device monitors a distribution service for available software changes based in part on the update policy. When a software change substantially satisfies the update policy, the network device is enabled to request delivery of that software change. The delivery of the software change may include the changed software and a component upon which the software change may be dependent. When and how the software changes are installed on the network device is determined in part by using the update policy.

### FIELD OF THE INVENTION

The present invention relates to updating of software, and in particular, to a system and method for distributing a software update to a network device, such as a network appliance.

### BACKGROUND

Software delivery to a remote computing system is one of the key challenges faced by software engineering in the twenty-first century. Although there are many factors defining the speed in which a system may be delivered to the remote computing system (development process, quality assurance, and the like), the mechanism which is used to deliver the software update plays a key role in the whole software engineering process. Delivery of a software update in a reliable and effective manner has been a challenge since the early days of personal computing. In the early days, typically, software updates were communicated to the remote computing system through an in-store purchase, the mail, and through similar transport mechanisms. The Internet, however, has recently provided an improved transport mechanism for the delivery of frequent software updates. The task remains, however, when and how to install the updated software, as well as which updates to install.

While many solutions may now exist that employ the Internet as a transport mechanism, they are primarily focused on a consumer, typically employing a personal computer, personal wireless device, and the like. Network devices, such as a network appliance, however, have different requirements for updating of its software. Often, network devices require a ‘hands-off’ approach to software updates that operate virtually automatically. Moreover, network devices may operate in a configuration that prioritizes its software updates in terms of timing, type, and the like. Therefore, there is a need in the industry for improved methods and systems for reliably distributing software updates to a network device over the network. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates one embodiment of an environment in which the invention operates;

FIG. 2 illustrates one embodiment of a distribution service for FIG. 1 employing proxy servers;

FIG. 3 illustrates another embodiment of the distribution service for FIG. 1 employing a peer to peer (P2P) configuration;

FIG. 4 illustrates a functional block diagram of one embodiment of a network device;

FIG. 5 illustrates a flow diagram generally showing one embodiment for distributing software change packages to a network device; and

FIG. 6 illustrates a flow diagram generally showing one embodiment of a process of managing a software change by a network device, according to one embodiment of the invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refers to an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

The term “packet” includes an IP (Internet Protocol) packet. The term “flow” includes a flow of packets through a network. The term “connection” refers to a flow or flows of packets that typically share a common source and destination.

Briefly stated, the present invention is directed to a system and method for enabling automatic, selection, delivery, and installation of a software change over a network to a network device. Unlike traditional solutions that are focused on software updates for a typical consumer computing device, the present invention further addresses a virtually automatic delivery of a software change to a network device, such as a network appliance.

Initially, an update policy associated with the network device is generated that may include information regarding how to select a software change, when the software change is to be delivered, when it is installed on the network device, and the like. In one embodiment, the software change is included within a change package that may include at least one of a file, a change descriptor, a package descriptor, and a deployment descriptor.

The network device monitors a distribution service for available software changes based in part on the update policy. When it is determined that a software change substantially satisfies the update policy, the network device requests delivery of the software change. The delivery of the software change may include software components and any related component dependency. In one embodiment, the software change includes a deployment instruction. When and how the software changes are installed on the network device is determined in part by using the update policy and the deployment instruction. In one embodiment, if it is determined that the installation failed, the network device is further configured to rollback the installation virtually automatically to a prior configuration.

Illustrative Operating Environment

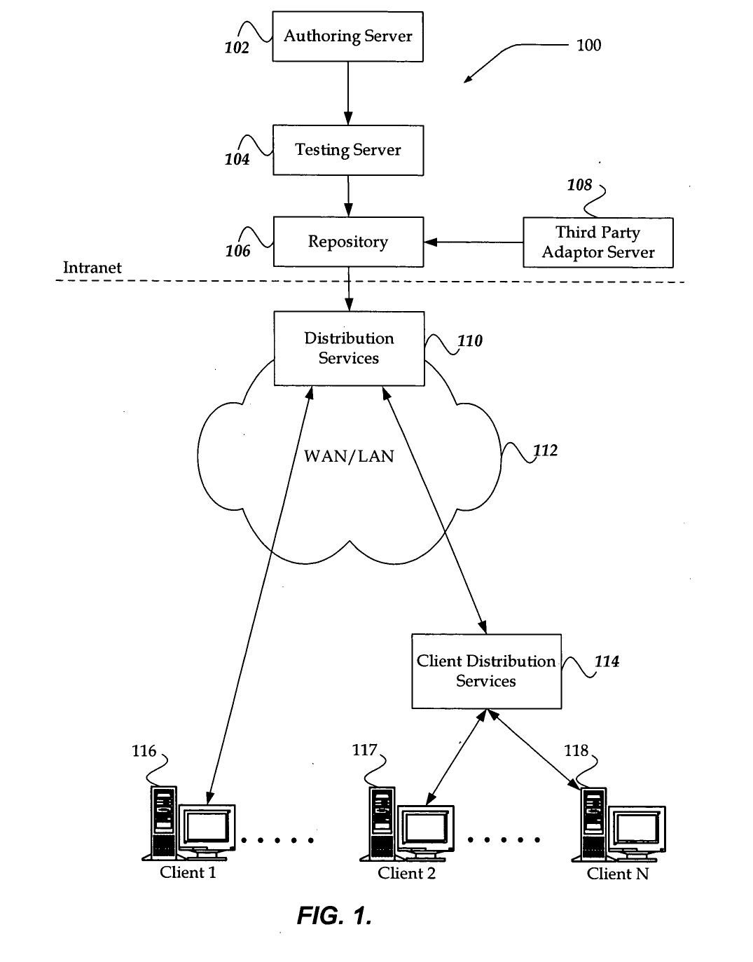

FIG. 1 illustrates one embodiment of an environment in which a system operates. Not all the components may be required to practice the invention, and variations in the arrangement and type of the components may be made without departing from the spirit or scope of the invention.

As shown in the figure, system 100 includes authoring server 102, testing server 104, repository 106, third party adaptor server 108, distribution services 110, Wide Area Network (WAN)/Local Area Network (LAN) 112, client distribution services 114, and clients 116-118.

Testing server 104 is in communication with authoring server 102, and repository 106. Repository 106 is also in communication with distribution services 110 and third party adaptor server 108. WAN/LAN 112 is in communication with distribution services 110, client distribution services 114, and client 116. Distribution services 110 are also in communication with client distribution services 114. Client distribution services 114 are also in communication with clients 117-118.

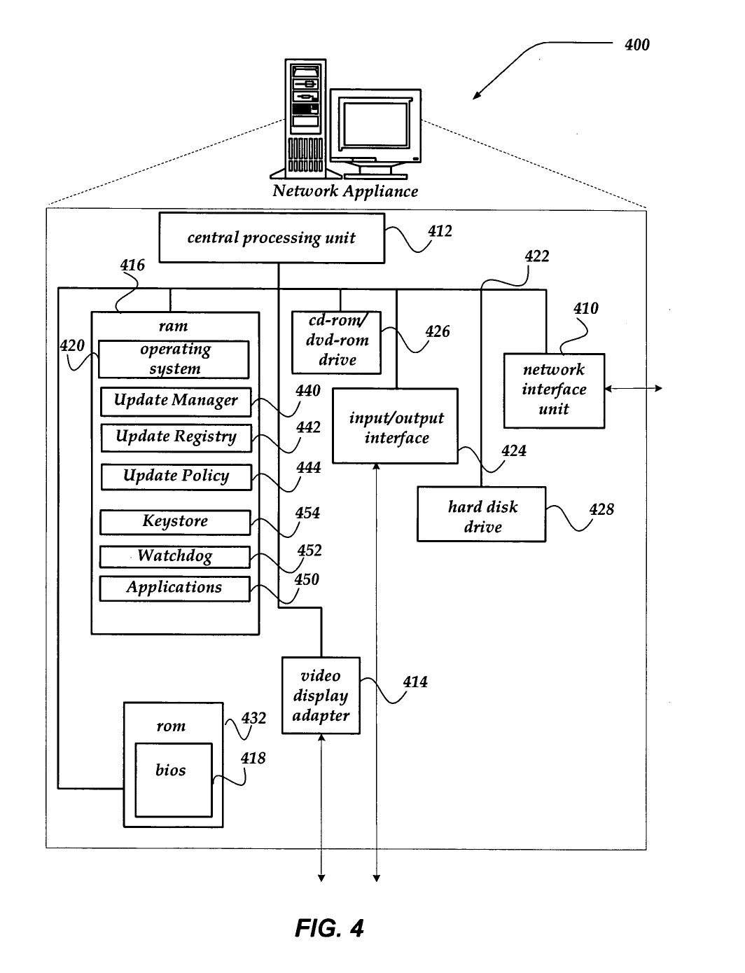

Clients 116-118 may be any network device capable of sending and receiving a packet over a network, such as WAN/LAN 112, to and from distribution services (such as 110, and client distribution services 114). The set of such devices may include devices that typically connect using a wired communications medium such as personal computers, multiprocessor systems, microprocessor-based or programmable consumer electronics, network PCs, and the like, that are configured to operate as a network device. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like, that are configured as a network appliance. Alternatively, clients 116-118 may be any device that is capable of connecting using a wired or wireless communication medium such as a PDA, POCKET PC, wearable computer, and any other device that is equipped to communicate over a wired and/or wireless communication medium, operating as a network device. As such clients 116-118 may be configured to operate as a web server, cache server, file server, router, file storage device, gateway, switch, bridge, firewall, proxy, and the like. In one embodiment, clients 116-118 are configured to operate as a network appliance, server appliance, internet appliance, intranet appliance, and the like. One embodiment of clients 116-118 is described in more detail below, in conjunction with FIG. 4.

WAN/LAN 112 couples client 116 and client distribution services 114 to distribution services 110. WAN/LAN 112 is enabled to employ any form of computer readable media for communicating information from one electronic device to another. In addition, WAN/LAN 112 can include the Internet in addition to local area networks (LANs), wide area networks (WANs), direct connections, such as through a universal serial bus (USB) port, other forms of computer-readable media, and any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, WAN/LAN 112 may include any communication method by which information may travel between network devices. Although not illustrated, a network substantially similar to WAN/LAN 112 may reside between and enable a communication between client distribution services 114 and at least one of clients 117-118.

Client distribution services 114 may include any computing device or devices capable of communicating packets to and from clients 117-118. Each packet may convey a piece of information. A packet may be sent for handshaking, i.e., to establish a connection or to acknowledge receipt of data. The packet may include information such as a request for delivery of a change package, a status request to determine whether a change package is available, a configuration command, a license request, certificate request, and the like. Generally, packets received by client distribution services 114 will be formatted according to TCP/IP, but they could also be formatted using another transport protocol, such as User Datagram Protocol (UDP), as well as HTTP, HTTPS, and the like.

Client distribution services 114 may be configured to operate as a website, a file server, a File Transfer Protocol (FTP) server, proxy server, P2P server, and the like. In one embodiment, client distribution services 114 resides within a client networking infrastructure, and is configured to negotiate a communication with distribution services 110 for a change package, license, certificate, and the like.

Devices that may operate as client distribution services 114 include, but are not limited to, personal computers, desktop computers, multiprocessor systems, microprocessor-based or programmable consumer electronics, network PCs, servers, routers, and the like. Similarly, client distribution services 114 may include several devices that are arranged to manage a communication with clients 117-118.

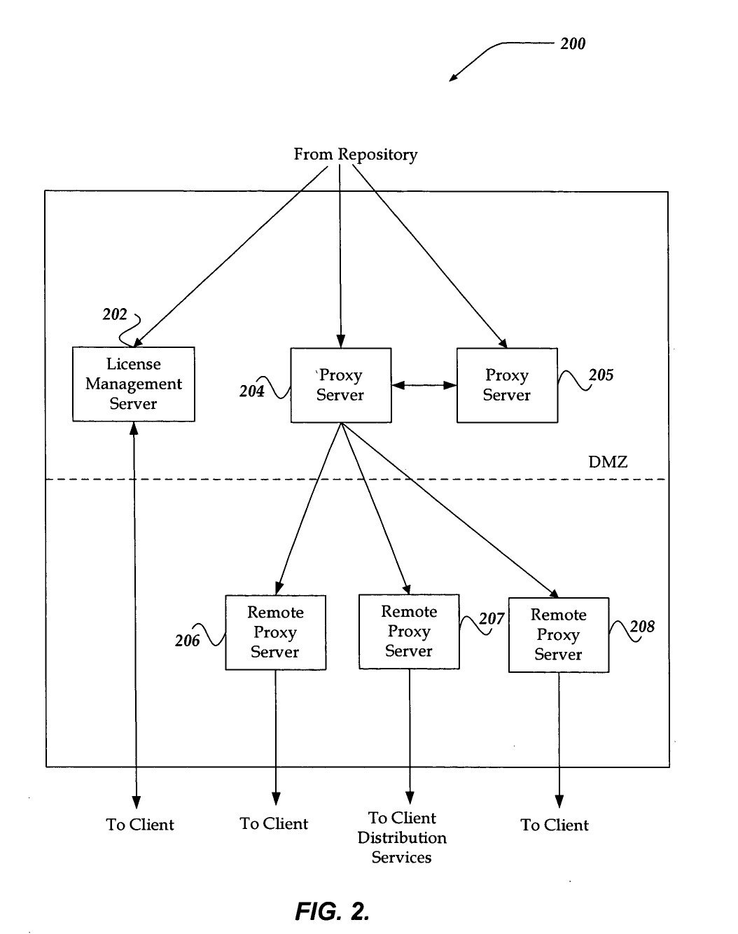

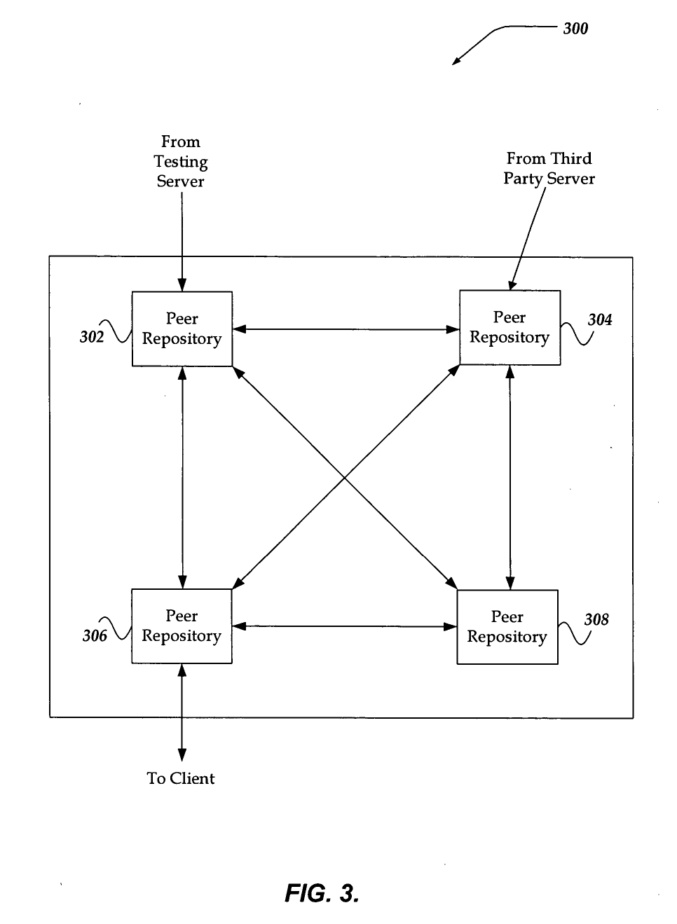

Distribution services 110 are described in more detail below in conjunction with FIGS. 2-3. Briefly, however, distribution services 110 may include any computing device or devices configured to distribute a software change, license, certificate, subscription, request, response, and the like, between clients 116-118, client distribution services 114 and repository 106. Devices that may operate as distribution services 110 include, but are not limited to, personal computers desktop computers, multiprocessor systems, microprocessor-based or programmable consumer electronics, network PCs, servers, and the like.

Although not shown, distribution services 110 may also be in communication with third-party adapter server 108, such that at least one third-party software change may be made available to client distribution services 110.

Authoring server 102 and testing server 104 may include any computing device capable of managing a software update during a software product development process, and the like. Devices that may operate as authoring server 102 and testing server 104 include, but are not limited to, personal computers, desktop computers, multiprocessor systems, microprocessor-based or programmable consumer electronics, network PCs, servers, and the like.

Authoring server 102 may include authoring tools to enable a developer, and the like, to manage the software change, upload a new software change, maintain a related software component, associated file, and the like. Authoring server 102 may enable the management of the software update, and the like, as a software component in a file structure, database, configuration tracking system, and the like. Software components managed by authoring server 102 may include a piece of a software system, a coupled piece of software from another system, and the like, including, but not limited to a binary file, configuration file, deployment procedure, test procedure, and the like. Such software components may be aggregated into a change package that may include the software change and a deployment descriptor. The deployment descriptor may include a command configured to enable deployment of the change package, including, but not limited to, a pre-install command, a pre-update command, a file deployment command, a test command, a post-update command, and a post-install command.

In one embodiment, the change package may further include a software change descriptor. In one embodiment, the change descriptor may include at least one of an identifier, a feature descriptor associated with the software change, an impact level such as high, medium, low, and the like, an update type, such as security bug fix, new feature, anti-virus, and the like, a short description, a full description, whether the software change may require a reboot of the client, a package list, and the like.

A software change may include one of more software files that have a dependency relationship. A software change need not be associated with a software version release number, and the like, however. For example, a software change, change package, and the like, may include one or more files that are a subset of a software version release, span several software version releases, and the like. As such, the present invention enables management of software updates independent of software release numbering, which in turn enables an increased flexibility and efficiency in managing of software updates.

Authoring server 102 may further enable a developer, manager, and the like, to digitally sign any file. Virtually any digital signature mechanism may be employed, including MD5, Secure Hash Algorithm (SHA), and the like. In one embodiment, a public/private key infrastructure, such as X.509, is employed to manage encryption and signing of a file.

Testing server 104 may include testing tools, such as quality assurance tools, and the like, that enable the testing, verification, validation, and the like, of a software change received from authoring server 102, third-party adaptor server 108, and the like. Testing server 104 may further enable a tester, manager, and the like, to digitally sign any file, employing virtually any digital signature mechanism, including those substantially similar to ones employed on authoring server 102.

Devices that may operate as testing server 104 include, but are not limited to, personal computers desktop, computers, multiprocessor systems, microprocessor-based or programmable consumer electronics, network PCs, servers, and the like.

Third-party adaptor server 108 may include any computing device capable of enabling delivery of a third-party change package to repository 106, where the third-party change package is configured substantially similar to other change packages residing within repository 106. Although not shown, third-party adaptor server 108 may further enable delivery of the third-party change package to testing server 104, authoring server 102, and the like.

Third-party adaptor server 108 provides a framework to enable development and maintenance of a change package, software change, and the like, obtainable from a third-party. In one embodiment, third-party adaptor server 108 enables a third-party to provide the software change as digitally signed files that may be forwarded to authoring server 102, testing server 104, and the like, for additional development, test, and preparation for release to repository 106.

Devices that may operate as third-party adaptor server 108 include, but are not limited to, personal computers desktop computers, multiprocessor systems, microprocessor-based or programmable consumer electronics, network PCs, servers, and the like.

Repository 106 may include any computing device or devices capable of receiving a change package from testing server 104, third-party adaptor server 108, and the like, and maintaining the change package ready for distribution. Devices that may operate as repository 106 include, but are not limited to, personal computers, desktop computers, multiprocessor systems, microprocessor-based or programmable consumer electronics, network PCs, servers, and the like.

Repository 106 may include a web service, FTP service, and the like, configured to manage the change package, and related information. In one embodiment, repository 106 includes a storage structure for maintaining trust information, such as public keys, signatures, access control lists, revocation lists, and the like. Repository 106 may also include subscription information, observer mechanisms, and the like, that enable a client, such as client 116, client distribution services 114, and the like, to monitor an availability of a change package, and associated information.

Typically, authoring server 102, testing server 104, and repository 106 reside hidden behind a business's firewall, intranet, and the like. Additionally, although separate devices are illustrated for authoring server 102, testing server 104, repository 106, and third-party adaptor server 108, the invention is not so limited. For example, the functionality of these devices may be reconfigured and arranged in virtually any combination, across one or more devices, with some, all, or even none of the devices within the business's intranet.

FIG. 2 illustrates one embodiment of a distribution service operable within FIG. 1 employing proxy servers. However, not all of these components may be required to practice the invention, and variations in the arrangement and type of the components may be made. Distribution service 200 may also include more components than those shown in the figure.

As shown in the figure, distribution system 200 includes license management server 202, proxy servers 204-205, and remote proxy servers 206-208. Proxy server 204 is in communication with remote proxy servers 206-208 and proxy server 205. Although not shown, proxy server 204 may also be in communication with license management server 202.

Proxy servers 204-205 and remote proxy servers 206-208 may include any network device that is configured to act on behalf of another device, such as clients 116-118, client distribution services 114, and repository 106. In one configuration all change packages, requests for change packages, notifications of an availability of a change package, and the like, are communicated through proxy server 204. In another embodiment, proxy server 205 is also enabled to communicate change packages and the like, between clients 116-118, client distribution services 114, and repository 106 of FIG. 1. In another embodiment, proxy server 205 is configured as a fail-over device, to assume the responsibilities of proxy server 204 during a failure.

Proxy servers 204-205 and remote proxy servers 206-208 may be further configured to maintain a copy of information, including a change package, received from repository 106. Although not shown, proxy server 204 may also be in communication with third party adaptor server 108 of FIG. 1. As such proxy server 204 may receive a third-party change package from third party adaptor server 108, and provide the third-party change package to clients 116-118, and client distribution services 114 of FIG. 1.

Devices that may operate as proxy servers 204-205 and remote proxy servers 206-208 include, but are not limited to, personal computers, desktop computers, multiprocessor systems, microprocessor-based or programmable consumer electronics, network PCs, servers, and the like. In one embodiment, at least one of proxy servers 204-205 and remote proxy servers 206-208 is configured to operate as at least one of a reverse proxy server.

A difference between proxy servers 204-205 and remote proxy servers 206-208 includes their logical location. For example, in one embodiment, proxy servers 204-205 are located within a demilitarized zone (DMZ) of a networking infrastructure, remote proxy servers 206-208 are located in various regional data centers. For example, remote proxy server 206 may be located and configured to provide services to the Americas, while remote proxy server 207 is located and configured to provide services to Europe. Remote proxy server 208 may be located and configured to provide services to Asia, and the like. In addition, a remote proxy server can be deployed at the client's site.

As configured, proxy servers 204-205 and remote proxy servers 206-208 may receive a subscription from a client, another distribution service and the like that enables the client, distribution service, and the like to monitor for the availability of a change package. In one embodiment, the subscription request includes information associated with the repository of interest, and a trust policy associated with the client. When it is determined that a change package is selected for delivery to a client, another distribution service, and the like, proxy servers 204-205 and remote proxy servers 206-208 may obtain the change package from repository 106 (of FIG. 1), third-party adaptor server 108 (of FIG. 1), and the like, and enable the distribution of the selected change package to the requestor.

License management server 202 may include any network device that is configured to maintain public key certificates, software licenses, and the like, that enable access to and validation of a change package. In one embodiment, license management server 202 further includes a control list, revocation list, and the like, configured to restrict access to the change package.

Devices that may operate as license management server 202 include, but are not limited to, personal computers desktop, computers, multiprocessor systems, microprocessor-based or programmable consumer electronics, network PCs, servers, and the like.

FIG. 3 illustrates another embodiment of the distribution service of FIG. 1 employing a peer to peer (P2P) configuration. However, not all of these components may be required to practice the invention, and variations in the arrangement and type, and number of the components may be made.

As shown in the figure, distribution services 300 include peer repositories 302-308. Peer repository 302 is in communication with peer repositories 304-308. Peer repository 304 is also in communication with peer repositories 306-308. Peer repository 306 is further in communication with peer repository 308.

As arranged in distribution services 300, peer repositories 302-308 are arranged in a peer-to-peer (P2P) networking configuration to provide a change package to a client, another distribution service, and the like. In the P2P configuration, the change package may reside on virtually any of the peer repositories 302-308. Moreover, a third-party change packages may similarly reside on any one of more of peer repositories 302-308. Additionally, virtually any one or more of peer repositories 302-308 may be configured to maintain and provide services substantially similar to license manager server 202 of FIG. 2.

In one embodiment, distribution services 300 employs concepts for P2P networking and communications, as described by the Project JXTA, an open source project, described further at http://wwwjxta.org. For example, distribution services 300 may employ JXTA, or virtually any other P2P mechanism, to enable a peer network that creates a virtual, ad hoc network on top of existing networks, virtually hiding their underlying structures. In one embodiment of distribution services 300, virtually any peer can interact with any other peer, regardless of location, type of device, operating environment, and the like - even where a peer, resource, and the like is located behind a firewall, or on a different network transport.

Distribution services 300 may employ virtually any technology, and standard, including but not limited to, HTTP, TCP/IP, XML, and the like. Moreover, distribution services 300 may employ any of a variety of security mechanisms such as Transport Layer Security (TLS), digital certificates, and the like, to enable security while facilitating delivery of the change package, and other information.

Devices that may operate as peer repositories 302-308 include, but are not limited to, personal computers, desktop computers, multiprocessor systems, microprocessor-based or programmable consumer electronics, network PCs, servers, and the like.

FIG. 4 illustrates a functional block diagram of one embodiment of a network device 400 to which a software update may be delivered. Network device 400 may include many more components than those shown. The components shown, however, are sufficient to disclose an illustrative embodiment for practicing the invention.

Network device 400 includes processing unit 412, video display adapter 414, and a mass memory, all in communication with each other via bus 422. The mass memory generally includes RAM 416, ROM 432, and one or more permanent mass storage devices, such as hard disk drive 428, tape drive, optical drive, and/or floppy disk drive. The mass memory stores operating system 420 for controlling the operation of network device 400. Any general-purpose operating system may be employed. Basic input/output system (“BIOS”) 418 is also provided for controlling the low-level operation of network device 400.

As illustrated in FIG. 4, network device 400 also can communicate with the Internet, or some other communications network, such as WAN/LAN 112 in FIG. 1, via network interface unit 410, which is constructed for use with various communication protocols including the TCP/IP protocol. Network interface unit 410 is sometimes known as a transceiver or transceiving device.

The mass memory as described above illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

In one embodiment, the mass memory stores program code and data for implementing operating system 420. The mass memory may also store additional program code and data for performing the functions of network device 400. One or more applications 450, and the like, may be loaded into mass memory and run on operating system 420. As shown in the figure, update manager 440, update registry 442, update policy 444, keystore 454, and watchdog 452 are examples of applications that may run on operating system 420.

Update manager 440 may include software that is configured to manage a software change process for network device 400. Update manager 440 may be employed to generate and maintain update policy 444 for determining which change package is to be selected, delivered, and installed. Update manager 440 may further employ update policy 444 to determine when to receive and install the selected change package. As such, in one embodiment, update policy 444 may include at least one condition, test, criterion, event, and the like, for determining the selection, the delivery, and/or the installation of a change package.

Update manager 440 may be configured further to employ keystore 454 to access a public encryption key associated with a Certification Authority (CA), and the like. The public encryption key may enable update manage 440 to determine the validity and integrity of the selected change package and its contents.

Update manager 440 may also be configured to record information associated with the installed change package into update registry 442. Update registry 442 may include a namespace/name/pair database, file, and the like, that is configured to maintain a property related to network device 400, including, but not limited to a component change, version, change number, dependency, and the like.

Optional watchdog 452 may be employed to monitor the configuration of network device 400 and provide an alert when an attempt to change the configuration is made. As such, update manger 440 may be configured to communicate with watchdog 452 to disable the alert during an authorized configuration change.

Update manager 440 may also provide additional services including an abstract transport layer which is configured to define how a change package is obtained. In one embodiment, the change package is obtained through a network transport, which handles files stored in a back-end infrastructure.

Update manager 440 may further provide an abstract service manager layer which establishes how services, daemons, and the like, may be handled during an update. For example, the abstract service manager may create an object that knows how to handle a message, and request watchdog 452 to stop an alert.

Update manager 440 also may provide an abstract deployment layer which defines how the contents of a change package, including files, may be deployed on network device 400, how rollback of an installation may operate, and the like.

Network device 400 may also include an SMTP handler application for transmitting e-mail, an HTTP handler application for receiving and handing HTTP requests, and an HTTPS handler application for handling secure connections. The HTTPS handler application may initiate communication with an external application in a secure fashion. Network device 400 is not limited however, to these handler applications, and many other protocol handler applications may be employed by network device 400 without departing from the scope of the invention.

Network device 400 also includes input/output interface 424 for communicating with external devices, such as a mouse, keyboard, scanner, or other input devices not shown in FIG. 4. Likewise, network device 400 may further include additional mass storage facilities such as CD-ROM/DVD-ROM drive 426 and hard disk drive 428. Hard disk drive 428 is utilized by network device 400 to store, among other things, application programs, databases, and the like.

Illustrative Method of Ensuring Reliability of a Mirrored Connection

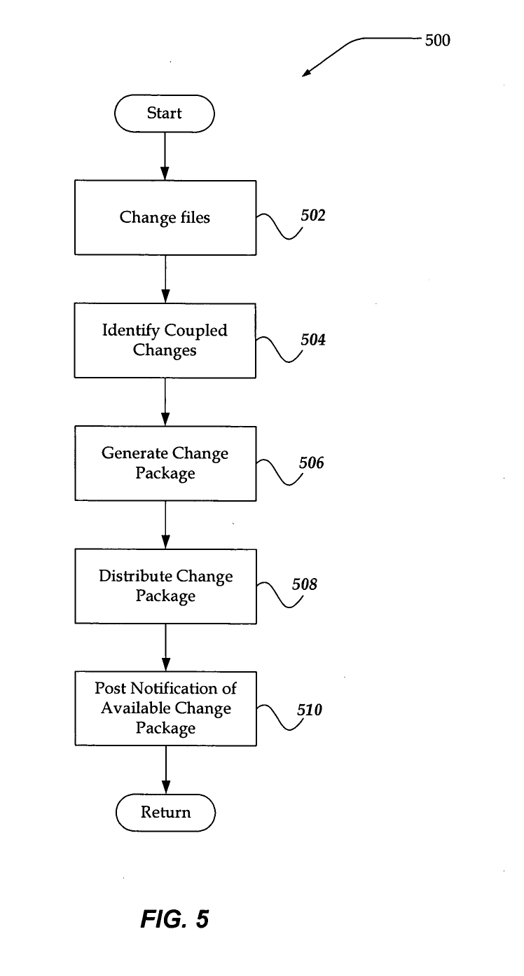

FIG. 5 illustrates a flow diagram generally showing one embodiment for distributing a software change package to a client, such as a network device, according to one embodiment of the invention. In one embodiment, process 500 is implemented across repository 106 and distribution services 110 of FIG. 1.

Process 500 begins, after a start block, at block 502, if a file associated with a software application is changed. The changed file may include a source file, binary file, configuration file, deployment procedure file, test procedure file, and the like. Typically, the changed file comprises a component, such as a single piece of a software application, system, and the like. In one embodiment of the invention, the developer, tester, third-party, and the like, that provides the changed file also digitally signs the file using virtually any available digital signature mechanism, including but not limited to MD5, Digital Signature Standard (DSS), Secure Hash Algorithm (SHA), RSA, and the like.

In one embodiment, the digital signature uniquely identifies a role for the digital signer, such as developer, releaser, tester, third-party vendor, manager, and the like. Typically, the digital signature mechanism employs a private key to sign the changed file. The private key may be stored in a keystore local to the signer. The public key associated with the private key may be stored in a repository, such as on license management server 202 of FIG. 2, a third-party repository, and the like. The public key may be stored in the repository, or the like, in a certificate format, such as X.509, and the like. Such certificates may be digitally signed by a trusted Certification Authority (CA). A CA-root public key that is employed to validate the certificate may be installed in a network device's keystore, such as keystore 454 of FIG. 4. In one embodiment, the CA-root public key is made available to the client, such as a network device, through a license management server, and the like. However, the invention is not so limited, and virtually any trusted mechanism may be employed to provide the CA-root public key to the client.

Block 502 may be iterated upon as often as desired, or until, it is determined that a software change is ready for a client. There upon, the process proceeds to block 504, where a file, component, and the like, that the changed file is dependent upon is identified. The identified dependency may include, but is not limited to, an executable file, configuration file, deployment procedure, test procedure, and the like. Each coupled change may be digitally signed. In one embodiment, a default digital signature policy is deployed that identifies by whom and when each file, component, and the like, is to be signed. For example, one default digital signature policy may indicate that each deployment descriptor associated with a change package should be digitally signed by a manager, a security related file is digitally signed by a manager, a changed file is signed by a tester, and other related content is signed by a releaser.

Upon completion of block 504, the process continues to block 506, where components may be packaged into one or more change packages. The change package may include compressed files, components, and the like, a package descriptor, a change descriptor, and a deployment descriptor. In one embodiment, the package descriptor may include at least one of a component identifier, a version number, a change number, a condition, and an encryption flag. Each change package and its contents each may be digitally signed employing any of a variety of digital signature mechanisms.

The process continues next to block 508, where a change package, is distributed. Distribution of the change package may employ virtually any of a variety of mechanisms, including those described above in conjunction with FIGS. 2-3. Process 500 proceeds to block 510, where a notification of the available change is made available. Notification of an available change package may employ any of a variety of techniques, including preparing a list server message, posting a file on a server, and the like. In one embodiment, the notification is enabled such that a client may query a site for the presence of a new notification. Upon completion of block 510, the process returns to a calling process to perform other actions.

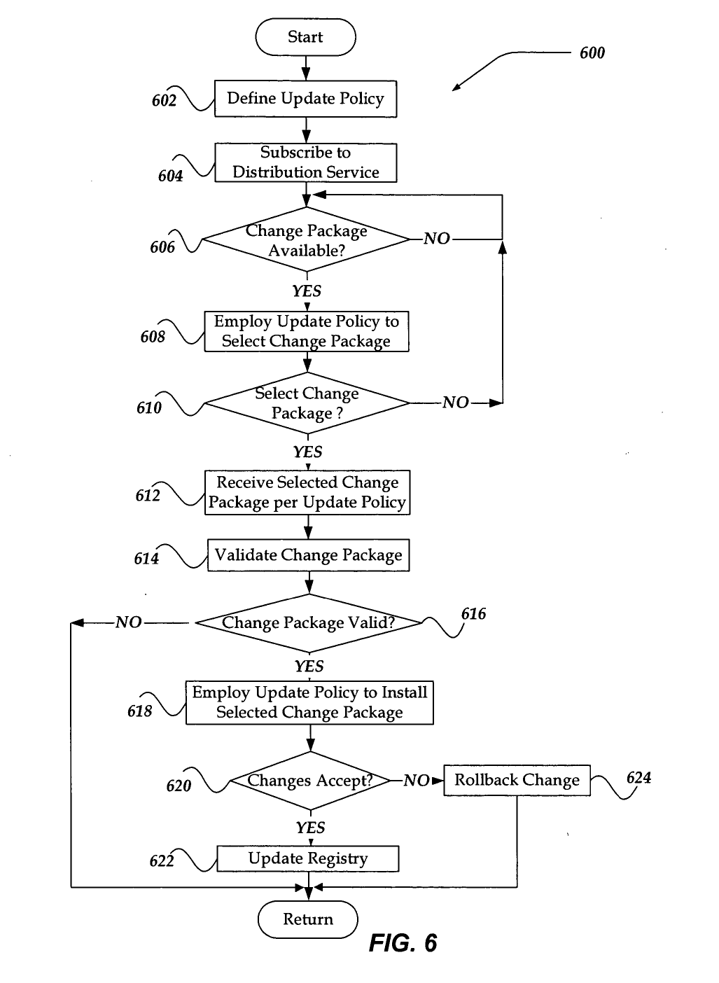

FIG. 6 illustrates a flow diagram generally showing one embodiment of a process for managing a software change by a network appliance. In one embodiment, process 600 is implemented within clients 116-118 of FIG. 1.

Process 600 begins, after a start block, at block 602, where an update policy is defined for a client, such as a network device. The update policy identifies various actions of the client. For example, the update policy may include one or more criteria that are employable to determine a selection of a software change, a delivery of the software change, an installation of the software change. The update policy may include, for example, a selection criterion that indicates that anti-virus software changes are to be selected for installation as soon as possible. The update policy may however, indicate that a high impact software change is to be installed only during a pre-determined period of time, such as when the client may be lightly employed.

In one embodiment, the update policy is an XML file with a rule, criterion, event, condition, and the like. The update policy may include one or more profiles, including, but not limited to, an anti-virus signature profile including rules for selecting and installing anti-virus signatures, a medium-impact update profile with a rule for installing a medium impact change. In another embodiment, an update policy is generated with a rule, condition, criterion, and the like, to select, receive, and install, a full update, including any change package that may include a latest change to a desired component. In yet another embodiment, an absence of an update policy may indicate that a full update is to be performed, for example, when the client has remained off for a pre-determined period of time, is installed into a network, and the like.

The update policy may further indicate how often to schedule a full update, an anti-virus signature profile, a medium impact profile, and the like. For example, the update policy may indicate that an anti-virus signature profile is scheduled to monitor for a change every X minutes (where X may be predetermined to be any number), and if an anti-virus signature change is identified, to select, and install the change.

Upon completion of block 602, the process proceeds to block 604, where the client subscribes to a distribution service. A subscription enables the client to listen to a specific distribution service to determine whether to receive a change package. The process continues next to decision block 606 where a determination is made whether a change package is available. In one embodiment, the update policy indicates a frequency for contacting the distribution service to determination whether a change package is available. If it is determined that there is no change package available, the process may continue to loop back to decision block 606 until a new change package is available. If it is determined that a change package is available, the process proceeds to block 608.

At block 608, the update policy may be employed to determine whether to select the available change package. Selection of the change package may be determined based on a variety of criteria, events, conditions, and the like, including, but not limited to, a hardware configuration of the client, a priority associated with the change package, a software configuration of the client, an impact associated with the change package, a schedule, and the like. Process 600 next proceeds to decision block 610 where a determination is made whether the change package is to be selected. If the change package is to be selected the process proceeds to block 612; otherwise, the process loops back to decision block 606.

At block 612, the client receives the selected change package based in part on the update policy. For example, the update policy may provide a criterion that indicates that a pre-determined size of a change package is to be delivered to (received by) the client during predetermined time.

In any event, once the change package is received by the client, the process continues to block 614, where the change package is validated. In one embodiment, validation may include verification of the digital signature associated with the change package, its contents, and the like. For example, in one embodiment, the MD5's for the change package and its contents may be determined. The client may then verify that the public key associated with the digital signature, MD5, and the like, is not present on a revocation list, expired, and the like. The client may also verify that the certificate associated with the public key is valid, by, among other actions, employing the CA-root's public key. The invention is not so limited, however, and virtually any technique may be employed to validate the integrity, source, and the like of the change package, including but not limited to, other cryptographic and non-cryptographic techniques.

The process next continues to decision block 616 where a determination is made whether the change package and its contents are valid. If it is determined that the change package and its contents are valid, processing continues to block 618. If, however, it is determined that the change package is not valid, processing returns to a calling process to perform other actions. In one embodiment, if it is determined that the change package is invalid, a validity failure message is communicated to the distribution services, system administrator, and the like.

At block 618, the update policy is employed to determine when and how to install the selected change package. High impact changes may be installed during a pre-determined time, while an anti-virus change may be installed as soon as possible, scheduled for another pre-determined time, and the like. In any event, when it is determined that the change package is to be installed, the client prepares for and installs the changes based in part on a set of deployment instructions. In one embodiment, preparation may include directing a watchdog mechanism to enable installation of the authorized change package. Moreover, deployment instructions, and other actions, instructions, and the like, may be logged for use in a rollback of the installed change package.

Process 600 continues next to decision block 620, where a determination is made whether the installation of the change package is acceptable. Acceptance of the change package may be based on a variety of pre-defined criteria, including but not limited to, whether there is a failure detected, and the like. If it is determined that the change is acceptable, processing continues to block 622, where a registry is updated to reflect the changes, and new configuration of the client. Upon completion of block 622, processing returns to a calling process to perform other actions.

However, if, at decision block 620, it is determined that the change package is not acceptable, processing branches to block 624, where the installed change package is un-installed, or rolled-back. In one embodiment, the deployment instructions, and the like that were logged during installation, along with any other pre-determined instructions are employed to enable a smooth rollback of the change package. In another embodiment, an error message, alert message, and the like is communicated to the distribution services, an administrator of the client, and the like, indicating that the selected change package was rolled back. Upon completion of block 624, processing returns to a calling process to perform other actions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Although the invention is described in terms of a packet communicated between a client device and a server, the invention is not so limited. For example, the packet may be communicated between virtually any resource, including but not limited to multiple clients, multiple servers, and any other device, without departing from the scope of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

1. A network device for managing a software change over a network, comprising:
a transceiver arranged to send and to receive a packet over the network;
a processor, coupled to the transceiver, that is configured to perform actions, including:
determining an update policy associated with the network device;
determining an availability of the software change based in part on the update policy;
selecting the software change based in part on the update policy;
receiving the software change through a distribution service according to the update policy; and
installing the software change on the network device according to the update policy.

2. The network device of claim 1, wherein the network device is at least one of a network appliance, server appliance, internet appliance, intranet appliance, web server, cache server, file server, router, gateway, switch, bridge, firewall, and a proxy.

3. The network device of claim 1, wherein the update policy further comprises at least one of a selection criterion, a delivery criterion, and an installation criterion.

4. The network device of claim 1, wherein the distribution service is further configured to enable access to the software change from at least one of a repository, a third-party service, a test server, and a development server.

5. The network device of claim 1, wherein the distribution service further comprises at least one of a reverse proxy server, and a peer-to-peer device.

6. The network device of claim 1, wherein selecting the software change further comprises determining the selection based in part on at least one of a hardware configuration of the network device, a priority associated with the software change, a software configuration of the network device, a type associated with the software change, a control list, an impact associated with the software change, and a schedule.

7. The network device of claim 1, wherein the software change is independent of a software version number.

8. The network device of claim 1, wherein installing the software change further comprises:
validating the integrity of the software change in part through a cryptographic mechanism.

9. The network device of claim 1, the software change further comprises a third-party change, wherein the third-party change is included in the software change at least in part by a third-party.

10. The network device of claim 1, wherein installing the software change further comprises generating a log that enables rollback of the installed software change.

11. The network device of claim 1, wherein the software change further comprises a change package that includes at least one of a binary file, a configuration file, a change descriptor, a package descriptor, test procedure, and a deployment descriptor.

12. The network device of claim 1, wherein the software change is digitally signed by at least one of a developer, releaser, tester, third-party, and a manager associated with the software change.

13. The network device of claim 1, wherein determining the availability of the software change further comprises subscribing to the distribution service.

14. A method for managing a software change to a network device over a network, comprising:
determining an update policy associated with software for the network device;
determining, over the network, an availability of the software change based in part on the update policy;
selecting the software change based in part on the update policy;
receiving the selected software change over a distribution service according to the update policy; and
installing the received software change on the network device according to the update policy.

15. The method of claim 14, wherein determining the update policy further comprises determining at least one of a selection criterion, a delivery criterion, and an installation criterion for the software change.

16. The method of claim 14, wherein determining an availability of the software change further comprises:
subscribing to the distribution service; and
monitoring the distribution service for the software change.

17. The method of claim 14, wherein selecting the software change further comprises determining the selection based in part on at least one of a hardware configuration of the network device, a priority associated with the software change, a software configuration of the network device, a type associated with the software change, a control list, an impact associated with the software change, and a schedule.

18. The method of claim 14, wherein the software change further comprises a change package that includes at least one of a binary file, a configuration file, a change descriptor, a package descriptor, test procedure, and a deployment descriptor.

19. The method of claim 14, wherein installing the received software change further comprises determining at least one of a priority, an impact, an integrity, and a time associated with the installation of the software change.

20. The method of claim 14, wherein the distribution service further comprises at least one of a reverse proxy server and a peer-to-peer distribution service.

21. A system for communicating a change package over a network, comprising:
a repository configured to store the change package;
a distribution service, coupled to the repository, that is configured to distribute the change package over the network; and
a client, coupled to the distribution service, that is configured to perform actions, including:
determining an update policy associated with the client;
determining an availability of the change package based in part on the update policy;
selecting the change package based in part on the update policy;
receiving the selected change package through the distribution service according to the update policy; and
installing the received change package on the client according to the update policy.

22. The system of claim 21, wherein the distribution service further comprises at least one of a reverse proxy server, and a peer-to-peer network.

23. The system of claim 21, wherein the repository further comprises at least one of trust information, subscription information, and an observer mechanism.

24. The system of claim 21, further comprising a license manager coupled to the distribution service, and enabled to provide at least one of a public key certificate, a software license, a control list, and a revocation list.

25. The system of claim 21, wherein the change package further comprises at least one of a software change, a change descriptor, a package descriptor, and a deployment descriptor.

26. The system of claim 21, wherein the client further comprises at least one of a network appliance, a server appliance, internet appliance, intranet appliance, cache server, web server, file server, router, gateway, bridge, firewall, and a proxy.

27. The system of claim 21, wherein the distribution service further comprises at least one of a reverse proxy server, and a peer-to-peer device.

28. An apparatus for managing a software change over a network, comprising:
a transceiver arranged to send and to receive a packet over the network;
a processor, coupled to the transceiver, that is configured to perform actions, including:
a means for determining an update policy associated with the apparatus;
a means for employing the update policy to perform further actions, including:
a means for determining an availability of the software change;
a means for selecting the software change;
a means for receiving the software change through a distribution service; and
a means for installing the software change on the apparatus.
